(19) United States
(12) Patent Application Publication
(10) Pub. No.: US 2019/0197559 A1
(43) Pub. Date: Jun. 27, 2019

(54) SYSTEM AND METHOD FOR USING A PERSONAL BOT

(71) Applicant: Verint Americas Inc., Alpharetta, GA (US)

(72) Inventor: Ashish Sood, Glasgow (GB)

(73) Assignee: Verint Americas Inc., Alpharetta, GA (US)

(21) Appl. No.: 16/226,969

(22) Filed: Dec. 20, 2018

Related U.S. Application Data
(60) Provisional application No. 62/609,519, filed on Dec. 22, 2017.

(51) Int. Cl. G06Q 30/00; G06F 16/9535

(52) U.S. Cl. CPC G06Q 30/016; G06F 16/9535

(57) ABSTRACT

The present invention is a method and system for utilizing a personal bot. The method receives a customer contact, adds the customer contact to a CEC desktop, accesses a customer service module to answer the customer contact, receives and analyzes a customer query within the customer contact, accesses at least one of a customer service module and a document database to formulate a response to the customer query, and calculates a confidence level in the response. The steps allow the customer service representative using the personal bot to access or pass along already-formulated answers to customer queries, increasing customer throughput.

### CROSS-REFERENCE TO RELATED APPLICATIONS

This application claims the benefit of prior-filed, co-pending U.S. Provisional Patent Application No. 62/609,519, filed on Dec. 22, 2017, the contents of which are incorporated herein by reference in their entirety.

### BACKGROUND

The present disclosure is directed to a system and method for contact centers with a computer-telephony arrangement, more specifically to a system and method for using a bot to assist a contact center agent.

In a customer service environment, when contacting an organization, customers typically desire human to human interaction in order to solve their problem or answer their query. However, organizations are continuously looking at ways of reducing their workforce (as this typically represents a large portion of their cost) whilst balancing the need to provide customer service to the organization's standard.

In recent years, the advent of synchronous text chat has meant that a customer service representative (CSR) can deal with both a telephone call as well as multiple text chat conversations simultaneously. There are limits today where a CSR can only handle a single telephone call at a time and a few text chats simultaneously. Too many text chats at one time may breach the cognitive load capabilities of a particular CSR. The current level of simultaneously interaction handling that a CSR can perform still does not meet the cost profile of certain organizations who look to reduce costs further.

### BRIEF SUMMARY

The present invention is a method for utilizing a personal bot. The method receives a customer contact, adds the customer contact to a CEC desktop, accesses a customer service module to answer the customer contact, receives and analyzes a customer query within the customer contact, accesses at least one of a customer service module and a document database to formulate a response to the customer query, and calculates a confidence level in the response.

The present invention also includes a system for utilizing a personal bot, comprising a processor and a non-transient computer readable medium programmed with computer readable code that upon execution by the processor causes the processor to execute the above method for utilizing a personal bot.

The present invention also includes a non-transient computer readable medium programmed with computer readable code that upon execution by a processor causes the processor to execute the above method for utilizing a personal bot.

### BRIEF DESCRIPTION OF THE DRAWING(S)

FIG. 1 illustrates a block diagram of an exemplary embodiment of a CEC system using a personal bot according to the present application.

FIG. 2 illustrates a block diagram of an exemplary embodiment of a system for utilizing a personal bot according to the present application.

FIGS. 3a, 3b, and 3c illustrate a flow chart of an exemplary embodiment of a method of utilizing a personal bot according to the present application.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

In order to increase the throughput of a particular CSR, a personal bot may augment the CSR and allow the CSR to effectively handle far more synchronous channels in parallel than is possible in current systems. The bot may autonomously handle parts of a phone call or text chat and only require the CSR to take over the chat or phone call when it can't progress or sees something it doesn't understand.

During a phone call or text chat where the CSR is in control, the CSR may ask the bot to perform basic tasks through text chat or over the phone call. For example, the CSR may ask the bot for customer identification and verification to capture a new address for a house move, or other script driven actions. The bot will suggest when it can take on repetitive tasks such as sending terms and conditions by email or text chat or reading out terms on a call to the customer. The bot may also take over these tasks automatically. This will allow the CSR to deal with other interactions as necessary. In certain embodiments, the bot will auto reply if its confidence level exceeds a given threshold. CSR control will move to become a monitor of multiple customer-bot interactions. When the bot's confidence level of how to proceed drops does not exceed the threshold, the CSR may take over or otherwise guide the bot.

The bot will learn to be like its human CSR counterpart, will communicate with the customer with the same mannerisms (e.g. grammar, style, speed) and, if for a phone call, with the same voice—this will make escalation transparent. For a video chat system, the video may be synthesized to look like the human agent.

The bot may give context and reminders to the human CSR, for example push compliance rules when a financial query is presented from customer. During interactions the bot and CSR will be able to privately communicate to each other (through text or other visual interface, voice or a direct neural interface). There will be prompts to ensure the CSR always knows whether it is the CSR or the bot who is currently speaking to or text chatting or video chatting to the customer.

The bot will learn from the CSR and, over time, increase the range of processes, issues and queries it can help with thereby increasing the parallel throughput of the CSR. The bot will monitor and analyze the CSR's actions and behavior and learning through desktop process analytics and text and speech analytics.

In this system, the personal bot is considered an extension of the human CSR. As it increases range and capabilities, the bot may be able to teach human CSRs as well.

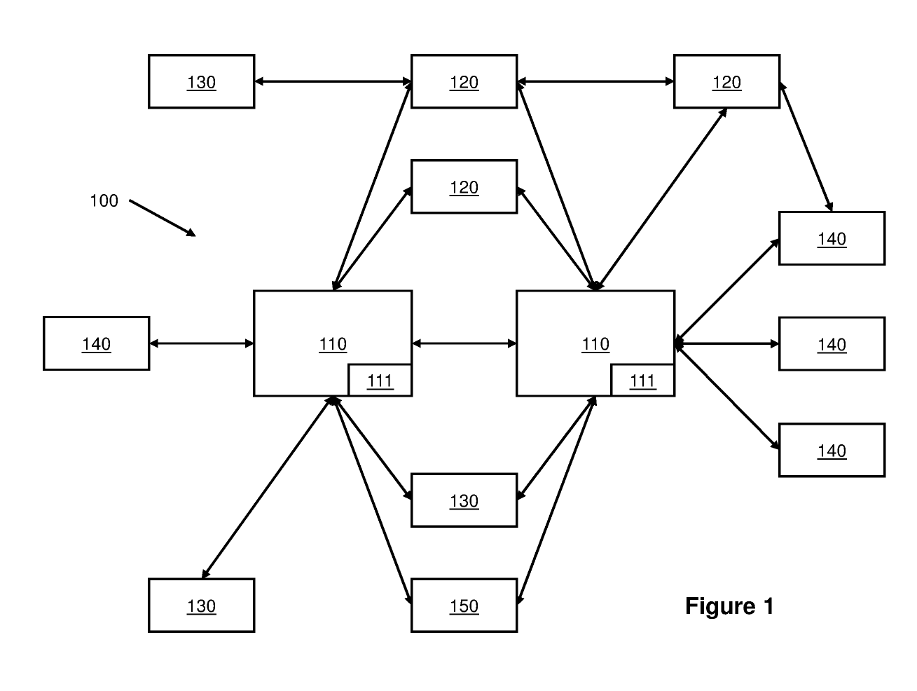

FIG. 1 illustrates a block diagram of an exemplary embodiment of a CEC system 100 using a personal bot 110 according to the present application. The CEC system 100 receives and utilizes data from at least one CSR (not shown), at least one external contact (by way of non-limiting example, a customer or potential customer), optionally at least one internal contact (by way of non-limiting example, a supervisor or quality assurance (QA) specialist), and/or any combination thereof. The CEC system 100 includes at least one personal bot 110 connected to at least one customer service module 120 and/or document database 130, at least one CEC desktop 140, and at least one optional system input 150.

The personal bot 110 is configured to constantly receive and analyze data within the CEC system 100. The analysis may be a real-time analysis of streaming data or a batch analysis of data. The personal bot 110 includes at least one set of analytics rules 111 used to analyze data. The analytics rules 111 determine responses to information extracted from the received data, governing which customer service modules 120 and/or document databases 130 are accessed by the personal bot 110, and what module functions and/or documents are utilized.

The analytics rules 111 can also be used to calculate confidence levels for personal bot 110 and to compare them to at least one given threshold. The threshold may be a part of analytics rules 111. A high confidence level (i.e., exceeding the threshold) indicates an acceptable likelihood that the response is accurate. A low confidence level (i.e., not exceeding the threshold) indicates an unacceptable likelihood that the response is accurate; in such a case, the personal bot 110 may bring the customer contact to the attention of a CSR.

The analytics rules 111 may be static or they may be dynamically updated by personal bot 110, customer service module 120, and/or a user or third party utilizing the CEC desktop 140 or the system input 150. Updates to the analytics rules 111 may be manual or automatic. Automatic updates to analytics rules 111 may be triggered by meeting certain criteria within analytics rules 111 of personal bot 110 or within the customer service modules 120, or may occur at predetermined intervals. Analytics rules 111 may be software programs or separate files executed by a software program.

While the exemplary embodiment includes two personal bots 110, the CEC system 100 may include more personal bots 110 or only one personal bot 110. In embodiments with multiple personal bots 110, the personal bots 110 may be constantly connected, periodically connected, interconnected through at least one customer service module 120 and/or document database 130, or separate. In embodiments with a single personal bot 110, personal bot 110 is connected, directly or indirectly, to all customer service modules 120, document databases 130, the CEC desktops 140, and/or the system inputs 150.

The customer service modules 120 are connected to personal bot 110, and optionally other customer service modules 120, document databases 130, and/or CEC desktops 140. In certain embodiments, some customer service modules 120 connect personal bot 110 to certain other customer service modules 120 and/or document databases 130. Customer service modules 120 provide different customer service functionalities to CEC system 100. A single customer service module 120 may perform multiple processes, a single process, and/or part of a larger process. In embodiments with multiple personal bots 110, each personal bot 110 may have its own set of customer service modules 120 or may share all or some specific customer service modules 120. Customer service modules 120 can be updated by adding, updating, or removing specific customer service modules 120. The connections between personal bots 110, customer service modules 120, document databases 130, and CEC desktops 140 may also be updated.

By way of non-limiting example, customer service modules 120 may perform voice and text analytics, QA analytics, analytics relating to usage of CEC desktop 140 or other available resources, and any other analysis related necessary for the activities of personal bot 110 during customer service interactions. Customer service modules 120 may provide the results of such analyses to personal bot 110 or to other customer service modules 120. By way of further non-limiting example, customer service modules 120 may also retrieve information for personal bot 110 and/or the CSR, such as customer profiles and history, scripts or templates for communication, internal customer service documentation, and any other customer service information. By way of further non-limiting example, customer service modules 120 may also interact with the functions of CEC desktop 140. Such interactions may allow another CEC desktop 140 to observe and/or share another CEC desktop 140, and utilize, update, or transmit or retrieve information to or from certain functions of the CEC desktop 140.

Document databases 130 are connected to personal bot 110 and may be connected to other document databases 130 and/or customer service modules 120. Document databases 130 store documents for use by CEC system 100. By way of non-limiting example, document databases 130 may store customer profiles and history, scripts or templates for communication, help screens, forms, internal customer service documentation, routing logs, analysis results, and any other customer service information. Documents stored in document databases 130 may be categorized by type, matter, applicable process, or any other possible classification schema. Document databases 130 and the information contained therein can be updated by adding or removing information to documents in document database(s) 130, adding or removing entire documents to or from document database(s) 130, or adding or removing entire specific document database(s) 130. The connections between personal bots 110, customer service modules 120, and document databases 130 may also be updated.

CEC desktop 140 receives and displays documents from document databases 130 and the results of any analyses from customer service modules 120, if applicable, as relayed by personal bot 110. Processes from customer service modules 120 may also interact with the processes of CEC desktop 140. By way of non-limiting example, if the personal bot 110 is unable to assist a customer, the CSR may use CEC desktop 140 to take over the interaction. If personal bot 110 is used to train a CSR, personal bot 110 may route training exercises or allow “eavesdropping” through CEC desktop 140.

System input 150 allows a user to update analytics rules 111. This allows a supervisor, system administrator, or other third party to make changes precisely to analytics rules 111, as opposed to updates which may be caused by usage or made through CEC desktop 140. System input 150 connects to at least one personal bot 110.

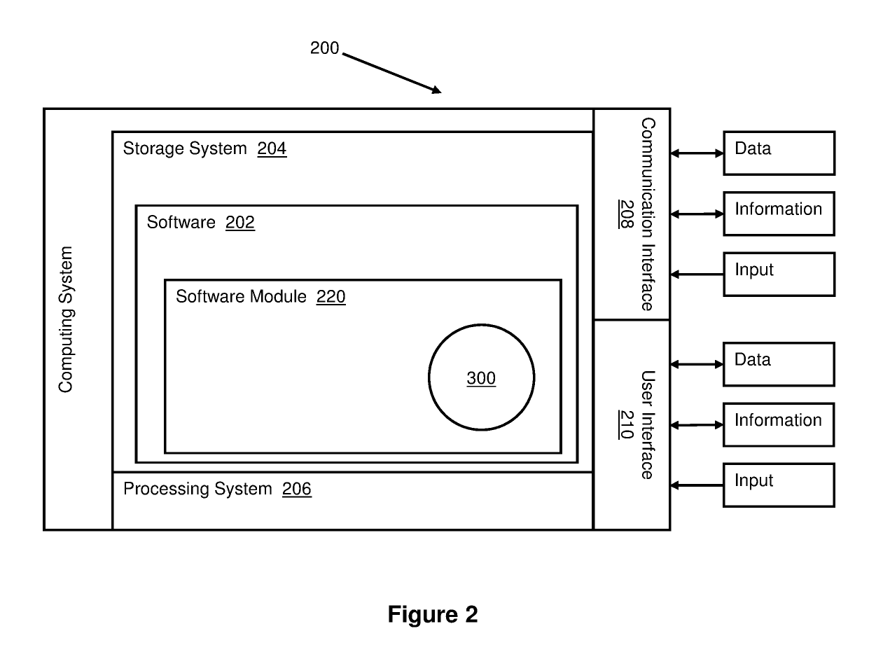

FIG. 2 illustrates a block diagram of an exemplary embodiment of a system 200 for utilizing a personal bot 110 according to the present application. The system 200 is generally a computing system that includes a processing system 206, a storage system 204, software 202, a communication interface 208, and at least one user interface 210. The processing system 206 loads and executes software 202 from the storage system 204, including a software module 220. When executed by computing system 200, software module 220 directs the processing system 206 to operate as described in herein in further detail in accordance with the method 300 for using the personal bot 110, described below.

The computing system 200 includes a software module 220 for performing the function of CEC system 100. Although computing system 200 as depicted in FIG. 2 includes one software module 220 in the present example, it should be understood that more modules could provide the same operation. Similarly, while the description as provided herein refers to a computing system 200 and a processing system 206, it is to be recognized that implementations of such systems can be performed using one or more processors, which may be communicatively connected, and such implementations are considered to be within the scope of the description. It is also contemplated that these components of computing system 200 may be operating in a number of physical locations.

The processing system 206 can comprise a microprocessor and other circuitry that retrieves and executes software 202 from storage system 204. The processing system 206 can be implemented within a single processing device but can also be distributed across multiple processing devices or sub-systems that cooperate in existing program instructions. Examples of processing systems 206 include general purpose central processing units, application specific processors, and logic devices, as well as any other type of processing device, combinations of processing devices, or variations thereof.

The storage system 204 can comprise any storage media readable by processing system 206, and capable of storing software 202. The storage system 204 can include volatile and non-volatile, removable and non-removable media implemented in any method or technology for storage of information, such as computer readable instructions, data structures, program modules, or other information. The storage system 204 can be implemented as a single storage device but may also be implemented across multiple storage devices or sub-systems. The storage system 204 can further include additional elements, such a controller capable of communicating with the processing system 206.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. In some implementations, the storage media can be a non-transitory storage media. In some implementations, at least a portion of the storage media may be transitory. Storage media may be internal or external to system 200.

As described in further detail herein, computing system 200 receives and transmits data through communication interface 208. The data can include verbal or textual communications, such as, but not limited to, queries to or from a customer, responses to such queries, and/or details about a request, a work order, or another set of data that will necessitate an interaction between a customer and the CSR and/or system 200. In embodiments, the communication interface 208 also operates to send and/or receive information, such as, but not limited to, information to/from other systems to which computing system 200 is communicatively connected, and to receive and process information as described in greater detail above. Such information can include responses to customer queries, average handling time, and the subject matter and nature of the communication requested by the customer.

The at least one user interface 210 can include a mouse, a keyboard, a voice input device, a touch input device for receiving a gesture from a user, a motion input device for detecting non-touch gestures and other motions by a user, and/or other comparable input devices and associated processing elements capable of receiving user input from a user. Output devices such as a video display or graphical display can display CEC desktop(s) 140, documents, or another interface further associated with embodiments of the system and method as disclosed herein. Speakers, electronic transmitters, printers, haptic devices and other types of output devices may also be included in the user interface 210. A CSR or other staff can communicate with computing system 200 through the user interface 210 in order to view documents, enter or receive data or information, enter information, manage an interaction, or any number of other tasks the CSR or other staff may want to complete with computing system 200.

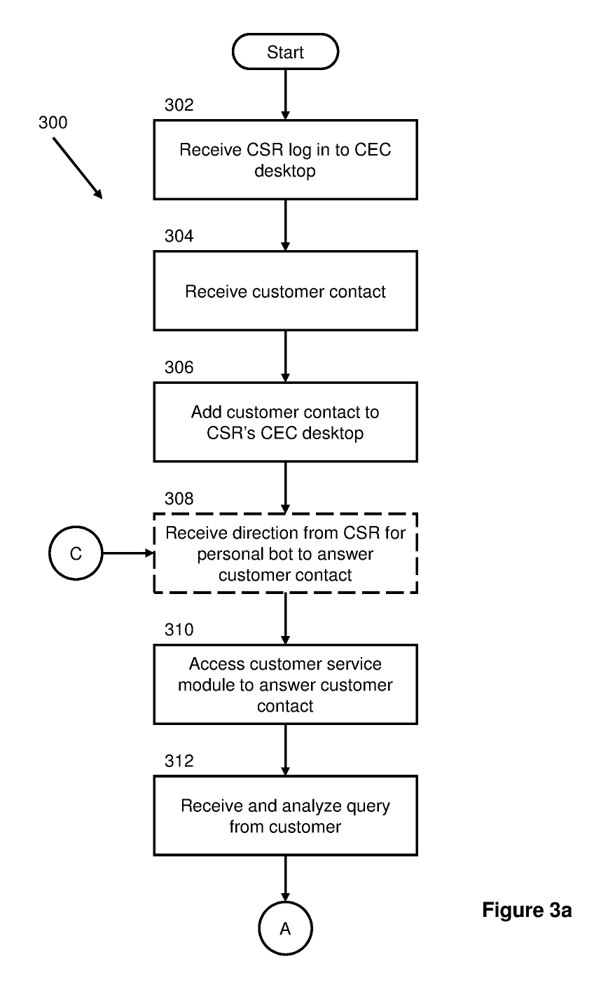

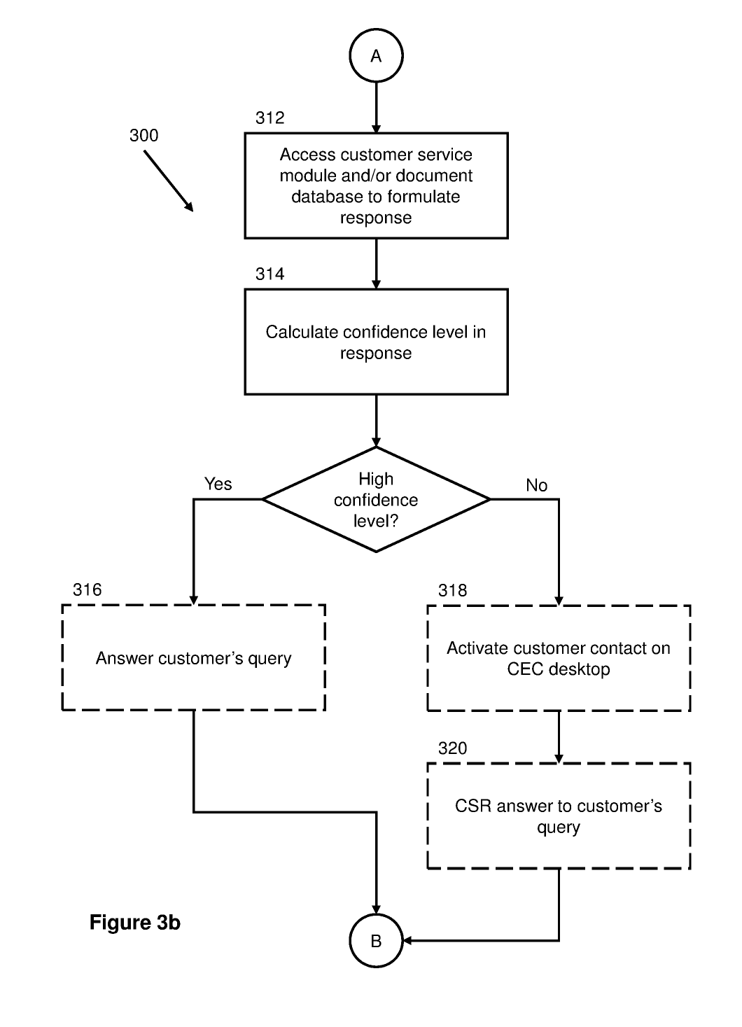

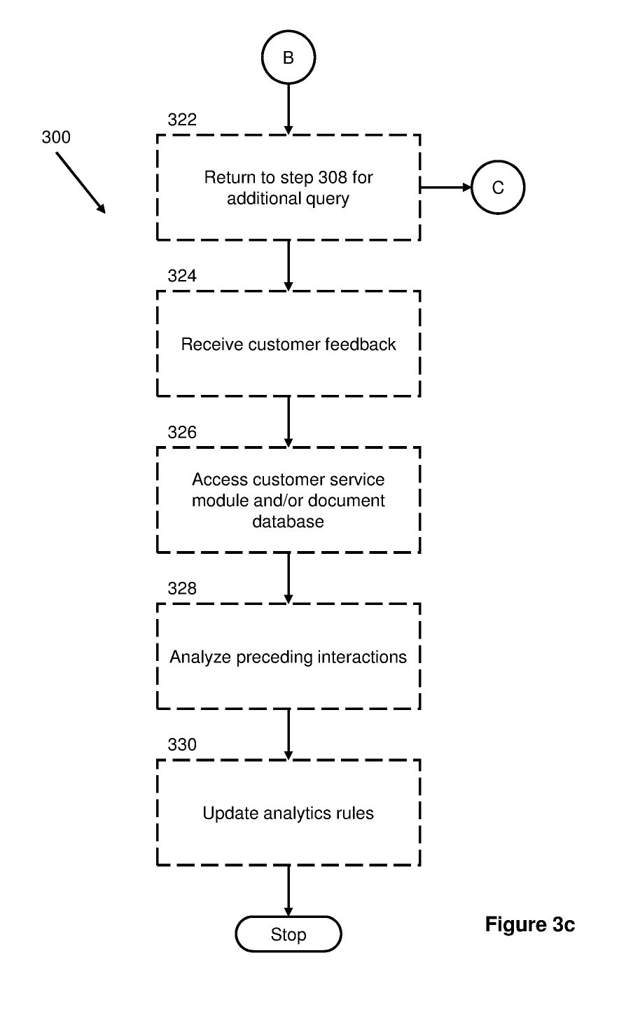

FIGS. 3a, 3b, and 3c illustrate a flow chart of an exemplary embodiment of a method 300 of utilizing a personal bot according to the present application.

As shown in FIG. 3a, in step 302, the CEC desktop 140 receives a CSR log in.

In step 304, the CEC system 100 receives a customer contact.

In step 306, the CEC system 100 adds the customer contact to the CSR's CEC desktop 140. The display on CEC desktop 140 may include prompts to ensure the CSR always knows whether it is the CSR or personal bot 110 who is currently speaking to, text chatting, video chatting, or otherwise interacting with the customer.

In optional step 308, CEC system 100 receives manual direction from the CSR for personal bot 110 to answer the customer contact.

In step 310, personal bot 110 automatically accesses a customer service module 120 to answer the customer contact.

In step 312, personal bot 110 receives and analyzes a query from the customer within the customer contact.

As shown in FIG. 3b, in step 314, personal bot 110 accesses at least one customer service module 120 and/or document database 130 to formulate a response to the customer's query.

In step 316, personal bot 110 calculates a confidence level in the response.

In optional step 318, personal bot 110 answers the customer's query with the response due to a high calculated confidence level. The answer to the query may take the form of outputting the response on CEC desktop 140, either simultaneously with providing the response to the customer, or for the CSR to provide to the customer. Alternately, personal bot 110 may simply answer the query without providing the response to the CSR.

In optional step 320, the customer contact is activated for the CSR on CEC desktop 140 due to a low calculated confidence level. CEC system 100 may provide a notification to the CSR on CEC desktop 140 that the customer contact is active, such as an audiovisual alert. Optionally, the notification may include the response to the query formulated by personal bot 110 and/or the calculated confidence level.

In optional step 322, the CSR answers the customer's query. This may require the CSR to manually access at least one customer service module 120 and/or document database 130 through CEC desktop 140.

As shown in FIG. 3c, in optional step 324, the customer provides another query and returns to step 308.

In optional step 326, CEC system 100 receives customer feedback for any of the preceding steps.

In optional step 328, personal bot 110 accesses at least one customer service module 120 and/or document database 130 to record any information related to the customer's query, such as, but not limited to, the nature of the query, the answer provided, or any customer feedback.

In optional step 330, personal bot 110 uses analytics rules 111 and data from the preceding interactions to analyze the preceding interactions.

In optional step 332, personal bot 110 updates analytics rules 111 to improve its performance.

Due to the multi-channeled nature of personal bot 110, any of the various steps may take place serially, simultaneously, or substantially overlapping with other steps.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A method for utilizing a personal bot, comprising:
receiving a customer contact;
adding the customer contact to a CEC desktop;
accessing a customer service module to answer the customer contact;
receiving and analyzing a customer query within the customer contact;
accessing at least one of a customer service module and a document database to formulate a response to the customer query; and
calculating a confidence level in the response.

2. The method of claim 1, further comprising receiving a log in from a CSR on the CEC desktop.

3. The method of claim 1, further comprising displaying a prompt on the CEC desktop showing whether a CSR or a personal bot is currently interacting with the customer.

4. The method of claim 1, further comprising receiving a manual direction from a CSR for a personal bot to answer the customer contact.

5. The method of claim 1, further comprising answering the customer query with the response if the calculated confidence level exceeds a threshold.

6. The method of claim 5, further comprising outputting the response on the CEC desktop.

7. The method of claim 6, further comprising providing the response to the customer simultaneously with outputting the response on the CEC desktop.

8. The method of claim 5, further comprising providing the response to the customer.

9. The method of claim 1, further comprising activating the customer contact for a CSR on CEC desktop if the calculated confidence level does not exceed a threshold.

10. The method of claim 9, further comprising providing a notification to the CSR on the CEC desktop that the customer contact is active.

11. The method of claim 10, wherein the notification includes at least one of the response to the customer query and the calculated confidence level.

12. The method of claim 1, further comprising receiving customer feedback.

13. The method of claim 1, further comprising accessing at least one of a customer service module and a document database to record any information related to the customer query.

14. The method of claim 1, further comprising analyzing the customer contact using analytics rules.

15. The method of claim 1, further comprising updating analytics rules.

16. The method of claim 1, further comprising receiving an additional customer query and repeating accessing a customer service module to answer the customer contact, receiving and analyzing a customer query within the customer contact, accessing at least one of a customer service module and a document database to formulate a response to the customer query, and calculating a confidence level in the response.

17. A system for utilizing a personal bot, comprising:
a processor; and
a non-transient computer readable medium programmed with computer readable code that upon execution by the processor causes the processor to execute a method for utilizing a personal bot, comprising:
receiving a customer contact,
adding the customer contact to a CEC desktop,
accessing a customer service module to answer the customer contact,
receiving and analyzing a customer query within the customer contact,
accessing at least one of a customer service module and a document database to formulate a response to the customer query, and
calculating a confidence level in the response.

18. The system of claim 17, further comprising at least one user interface upon which the CEC desktop is displayed.

19. The system of claim 17, further comprising analytics rules stored on the non-transient computer readable medium.

20. A non-transient computer readable medium programmed with computer readable code that upon execution by a processor causes the processor to execute a method for utilizing a personal bot, comprising:
receiving a customer contact;
adding the customer contact to a CEC desktop;
accessing a customer service module to answer the customer contact;
receiving and analyzing a customer query within the customer contact;
accessing at least one of a customer service module and a document database to formulate a response to the customer query; and
calculating a confidence level in the response.
